(19) United States
(12) Patent Application Publication
(10) Pub. No.: US 2026/0309868 A1
(43) Pub. Date: Oct. 8, 2026

(54) ULTRASONIC TRANSDUCER, METHOD FOR OPERATING AN ULTRASONIC TRANSDUCER, AND METHOD FOR MEASURING DISTANCE

(71) Applicant: TDK Electronics AG, Muenchen (DE)

(72) Inventors: Johannes Kofler, Graz (AT); Michael Pirolt, Graz (AT); Abdelouahid Zakriti, Deutschlandsberg (AT); Martina Lucchi, Graz (AT); Amira Hedhili, Graz (AT)

(21) Appl. No.: 19/481,499

(22) PCT Filed: May 2, 2024
(86) PCT No.: PCT/EP2024/062026

§ 371 Date: Nov. 4, 2025

(30) Foreign Application Priority Data
May 8, 2023 (DE) 102023111922.2

(51) Int. Cl. G01S 15/10; B06B 1/02; B06B 1/06; G01S 7/526

(52) U.S. Cl. CPC G01S 15/10; B06B 1/0215; B06B 1/0651; B06B 1/0666; G01S 7/526; B06B 2201/30

(57) ABSTRACT

In an embodiment an ultrasonic transducer includes an actuator, a damper, a detector, an adapter and a membrane, wherein the actuator is configured to excite the membrane to emit an ultrasonic wave, wherein the damper is configured to dampen a ringing of the membrane occurring after excitation by a damping signal, wherein the detector is configured to detect an amplitude of the ringing of the membrane, and wherein the adaptor is configured to determine the damping signal based on the detected amplitude of the ringing.

### CROSS-REFERENCE TO RELATED APPLICATIONS

This patent application is a national phase filing under section 371 of PCT/EP 2024/062026, filed May 2, 2024, which claims the priority of German patent application no. 102023111922.2, filed May 8, 2023, each of which is incorporated herein by reference in its entirety.

### TECHNICAL FIELD

The invention relates to an ultrasonic transducer, a method for operating an ultrasonic transducer, and a method for measuring distance.

### BACKGROUND

Piezoelectric ultrasonic transducers are used both for transmitting and receiving ultrasonic signals and are used, for example, as distance sensors in motor vehicles. However, such ultrasonic transducers conventionally continue to emit ultrasound even after all excitation of the transmission of ultrasonic signals has ceased. The reason for this is, in particular, ringing of a membrane of the ultrasonic transducer, by means of which the ultrasonic signals are generated. This ringing makes it difficult to detect an ultrasonic signal with the same membrane.

From the publications US 4,580,251, US6,731,569, and Liu et al. “Reducing ring-down time of pMUTs with phase shift of driving waveform.” Sensors and Actuators A 281 (2018) 100-107, and Wu et al. “A Novel Transfer Function Based Ring-Down Suppression System for PMUTs.” Sensors 2021, 21, 6414, ultrasonic transducers and methods for operating ultrasonic transducers are known.

### SUMMARY

Embodiments provide an improved ultrasonic transducer and an improved method for operating an ultrasonic transducer.

Embodiments provide an ultrasonic transducer, which comprises an actuating means, a damping means, a detecting means and an adapting means, as well as a membrane.

The actuating means is configured to excite the membrane to emit an ultrasonic signal. The damping means is configured to dampen a ringing of the membrane occurring after excitation by means of a damping signal. The detecting means is configured to detect the amplitude of the ringing of the membrane. The adapting means is configured to determine the damping signal in dependence of the detected amplitude of the ringing.

By detecting the amplitude of the ringing, it is possible in particular to use the adapting means to determine the damping signal in such a way that the ringing of the membrane can be effectively damped. Since the amplitude of the ringing is measured explicitly, it is possible to react dynamically to changes in, for example, environmental conditions or application requirements and to select a favorable damping of the ringing of the membrane.

During intended operation of the ultrasonic transducer, the actuating means can excite the membrane to emit an ultrasonic signal. A ringing of the membrane, which occurs in particular after the excitation of the membrane has ended, can be dampened by the damping means, whereby the damping signal is applied, for example, to the membrane. In particular, after the damping signal has been applied, an amplitude of the ringing can be detected by means of the detection element. In other words, the amplitude of the ringing can be measured. For example, the ringing of the membrane is converted into a voltage by means of the piezoelectric effect, from which the amplitude of the ringing of the membrane can be derived.

The damping signal can be determined by means of the adapting element. If, for example, the amplitude of the ringing of membrane is measured during operation before the damping signal is determined, the damping signal can advantageously be determined in such a way that the amplitude of the ringing of membrane is reduced or minimized. This means that the ultrasonic transducer can determine the damping signal as optimally as possible based on the detection of the amplitude of the ringing of the membrane, so that the ringing of the membrane is minimized as much as possible. The ultrasonic transducer can thus react dynamically to changes is environmental conditions, application requirements, measurement conditions, or the like, and determine the damping accordingly. This has the advantage that the ultrasonic transducer can be used in a wide region of external conditions and for measuring distances in a comparatively wide region.

In particular, the actuating means, the damping means, and the detecting means comprise a piezoelectric element. For example, the actuating means and the damping means and/or the detecting means are formed by the piezoelectric element. In particular, the actuating means, the damping means, and the detecting means are formed by the same piezoelectric element. That is, the ultrasonic transducer comprises, in particular, a piezoelectric element which acts as the actuating means, the damping means and the detecting means and preferably performs functions of the actuating means, the damping means and the detecting means. The piezoelectric element may be a piezoelectric disc.

It is possible that at least one of the actuating means, damping means, and detecting means comprises controlling electronics. The controlling electronics, for example, in the case of the actuating element and the damping element, provide a signal for the piezoelectric element or, in the case of the detecting means, evaluate a signal from the piezoelectric element.

It is possible that the piezoelectric element is connected to controlling electronics of the ultrasonic transducer. For example, the controlling electronics comprise at least one of the following electronic components: a microcontroller, an application-specific integrated circuit, also known as “ASIC” for short, a field-programmable gate array, also known as “FPGA” for short.

The controlling electronics are used, for example, to provide the damping signal to the damping means. For example, the damping means is electrically conductively connected to the controlling electronics.

In particular, the actuating means is configured to excite the membrane by means of an actuating signal. The actuating signal is provided, for example, by the controlling electronics. The actuating signal preferably essentially determines the ultrasonic signal emitted by the membrane and thus by the ultrasonic transducer. By specifying the actuating signal, the shape, length, frequencies, etc. of the ultrasonic signal can be determined.

The damping signal may be phase-shifted by 180° relative to the actuating signal. The phase shift of the damping signal enables efficient damping.

The actuating signal and the damping signal can have the same amplitude. This makes operation of the ultrasonic transducer particularly simple, as the actuating signal and the damping signal can essentially be generated in the same way.

It is possible that the damping signal comprises at least one damping pulse. The adapting means is configured in particular to determine at least one of the following parameters of the damping signal in dependence of the detected amplitude of the ringing: number of damping pulses, width of the at least one damping pulse, sequence of the at least one damping pulse.

For example, it is possible that the damping signal comprises one or more damping pulses. A width of the at least one damping pulse is determined in particular on the basis of the period during which the damping signal comprises the damping pulse. For example, the damping pulses may be rectangular pulses. This means that during the time in which the damping signal shows the damping pulse, the damping signal has a predetermined voltage that is not equal to zero. The time period during which the damping signal shows this voltage determines, in particular, the width of the damping pulse.

If, for example, the damping signal comprises only one damping pulse, the sequence of the one damping pulse may indicate the time period after the excitation of the membrane by the actuating means has ended the damping pulse occurs. In case that the damping signal comprises several damping pulses, the sequence indicates, for example, alternatively or additionally, the temporal sequence in which the damping pulses follow one another in the damping signal.

The damping signal comprises, for example, between two and 20 damping pulses, inclusive. A width of the at least one damping pulse can be, for example, between 0.002 milliseconds and 0.1 milliseconds, inclusive.

For example, a time interval between two damping pulses is between 0.002 milliseconds and 0.1 milliseconds, inclusive. In this case, the damping signal comprises at least two damping pulses in particular.

A waiting period between the end of excitation of the membrane by the actuating means and a first damping pulse of the damping signal may be between 0.02 milliseconds and 0.1 milliseconds, inclusive. The waiting period is thus measured, for example, from a time between the end of the actuating signal and the first occurrence of a damping pulse of the damping signal. The sequence of the damping pulses is determined in particular by the waiting period and the time interval between the damping pulses.

If the damping signal comprises at least two damping pulses, the damping pulses of the damping signal have a same amplitude. For example, the damping pulses are generated by switching a damping voltage on and off. The damping voltage is constant and varies only in sign, for example. This makes the damping signal particularly easy and therefore inexpensive to generate, as no adjustment of the amplitude is necessary.

Alternatively, or additionally, the damping pulses have a same pulse shape. For example, the damping pulses are rectangular pulses. The damping pulses preferably differ from one another only in their width and sign.

Preferably, the adapting means comprises an optimization algorithm executed on the controlling electronics. The optimization algorithm is in particular configured to determine an adapted damping signal in dependence of the detected amplitude of the ringing.

In particular, all features disclosed for the damping signal are analogously disclosed for the adapted damping signal and vice versa.

The optimization algorithm makes it possible to adapt the damping signal. To do this, the optimization algorithm receives the amplitude of the ringing of the membrane at least at one timing during damping using the damping means as a fitness parameter. During normal operation of the ultrasonic transducer, the optimization algorithm generates an adapted damping signal, for example, from the damping signal used to operate the damping means and the amplitude of the ringing of the membrane detected by the detecting means. In particular, the detection of the amplitude of the ringing of membrane is a prerequisite for the damping signal to be adapted by means of the adapting means.

In the event of subsequent damping, for example after a subsequent transmission of an ultrasonic signal by the ultrasonic transducer, the damping of the ringing of the membrane can be carried out with the adapted damping signal.

By re-detecting the amplitude of the ringing of membrane using the detection element, the adapted damping signal can then be further adapted or optimized using the adapting element or the optimization algorithm. This has the advantage that, in particular due to the detection of the amplitude of the ringing of the membrane, the ultrasonic transducer can constantly adapt and improve the damping, thereby achieving particularly effective damping. The damping signal can be adapted to several oscillation modes of the membrane in particular, and damping of the ringing is possible in an efficient manner.

In particular, an amplitude of the ringing of membrane damped by means of the adapted damping signal has a lower value than an amplitude of the ringing of the membrane damped by means of the damping signal. By executing the optimization algorithm, the damping of the amplitude of the ringing of membrane can be advantageously improved. If the optimization algorithm is executed multiple times, for example after each excitation of the membrane by the actuating means and subsequent damping by the damping means, the damping can be advantageously improved further and further during operation of the ultrasonic transducer.

The membrane of the ultrasonic transducer may have a freely oscillating surface of at least one square millimetre. This makes the membrane more robust and allows the ultrasonic transducer to be used under more unfavourable external conditions than, for example, a piezoelectric micromechanical ultrasonic transducer, which has a membrane with a surface area of less than one square millimetre.

The damping means is preferably configured to excite a damping mode of the membrane. The damping signal is preferably determined by the adapting means in such a way that the damping mode reduces the ringing of the membrane as effectively as possible. Advantageously, the excitation of a damping mode results in significantly higher damping than known damping methods.

Moreover, embodiments provide a method for operating an ultrasonic transducer. The ultrasonic transducer described here can be operated in particular using the method for operating an ultrasonic transducer. This means that all features disclosed for the ultrasonic transducer are also disclosed for the method and vice versa.

The method for operating an ultrasonic transducer, which comprises, for example, an actuating means, a damping means, a detecting means, and an adapting means, comprises in particular the following steps:
Exciting the membrane to emit an ultrasonic wave by means of the actuating means.

Damping an amplitude of the ringing of membrane by means of the damping means.

Detecting the amplitude of the ringing of the membrane at least at one timing after damping by the damping means by means of the detecting means.

Determining an adapted damping signal based on the amplitude of the ringing detected by the detecting means using the adapting means.

These steps are performed in particular in the specified order. Preferably, these steps are performed several times in succession. For example, each time the steps are performed, the adapted damping signal determined in the previous execution of the steps is used. This means that the damping signal is further adapted each time the steps are performed. For example, the damping signal is adapted using the optimization algorithm. This means that the damping signal is continuously improved and/or adapted to, for example, changed environmental conditions, application requirements, or measurement conditions. The method described here therefore enables particularly effective damping of the ringing of membrane.

The actuating means may excite the membrane with an actuating signal, and the damping means can dampen the membrane by means of the damping signal and/or the adapted damping signal. The damping signal and/or the adapted damping signal preferably follows the actuating signal without any waiting period. This means that after the actuating means has excited the membrane, the damping means immediately dampens the ringing of the membrane.

Moreover, embodiments provide a method for measuring a distance. The method for measuring distance uses an ultrasonic transducer described herein, which is operated in particular using a method for operating an ultrasonic transducer described herein. This means that all features disclosed for the method for operating the ultrasonic transducer and features disclosed for the ultrasonic transducer are also disclosed for the method for measuring distance and vice versa.

Preferably, exactly one ultrasonic transducer is used in the method for measuring distance. This means that the ultrasonic transducer serves both as a transmitting element for an ultrasonic wave and as a detection element for an ultrasonic signal reflected by the object to be measured.

In a transmission operation, the method for measuring distance includes, for example, an ultrasonic signal being emitted as a pulse from the ultrasonic transducer. After the pulse hits an object, it is reflected back at least partially. In a receiving operation, this reflected pulse is detected, allowing the transit time to be determined. Since ultrasonic signals propagate at known speeds in both air and water, the transit time can be used to calculate the distance to the target to be measured.

If the distance to the object is short, for example less than 10 centimeters, the ringing of the membrane of conventional ultrasonic transducers typically continues after the pulse has been emitted, which is why such ultrasonic transducers often cannot be used as both a transmitting and a receiving element at the same time.

With the ultrasonic transducer described here, it is possible to measure particularly short pulse transit times, i.e., particularly short distances, with only a single ultrasonic transducer, as effective damping of the ringing of membrane is achieved.

In particular, the method for measuring distance can be used to measure objects at a distance of between 4 centimeters and 2 meters, inclusive.

### BRIEF DESCRIPTION OF THE DRAWINGS

Further advantages and advantageous embodiments and further developments of the method for operating an ultrasonic transducer and the ultrasonic transducer will become apparent from the exemplary embodiments described below in connection with schematic drawings. Identical, similar, and equally functioning elements are assigned with the same reference symbols in the figures. The figures and the relative sizes of the elements shown in the figures are not necessarily to be regarded as true to scale. Rather, individual elements may be exaggerated in size for better representation and/or better understanding.

In the Figures:

FIG. 1 shows an ultrasonic transducer according to a first exemplary embodiment;

FIG. 2 shows a schematic illustration of a method for operating an ultrasonic transducer according to a first exemplary embodiment;

FIG. 3 shows an example of an actuating signal and a damping signal as used in the method described herein;

FIG. 4 shows an example of a damping signal as used in the method described herein;

FIG. 5 shows a graphical representation of ringing of a membrane damped with a damping signal as described herein, compared to a membrane without a damping signal;

FIG. 6 shows a graphical representation of a frequency analysis of ringing of a membrane damped with a damping signal as described here, compared to a membrane without a damping signal;

FIGS. 7 and 8 show graphical representations of a result of a distance measurement using a method described herein;

FIG. 9 shows a graphical representation of a signal of a damped membrane displacement; and

FIGS. 10 and 11 show graphical representations of a signal of an ultrasonic signal that was reflected by an object to be measured and received by the ultrasonic transducer.

### DETAILED DESCRIPTION OF ILLUSTRATIVE EMBODIMENTS

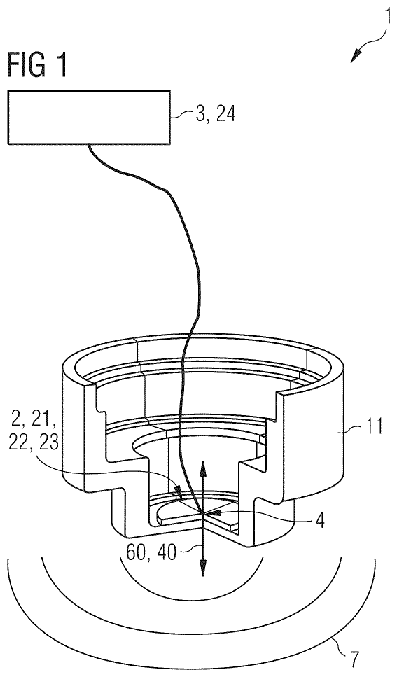

The ultrasonic transducer 1 according to FIG. 1 comprises an actuating means 21, a damping means 22, a detecting means 23, and an adapting means 24. The actuating means 21, the damping means 22, and the detecting means 23 are formed with a piezoelectric element 2. The adapting means 24 is formed with controlling electronics 3. The controlling electronics 3 is configured to excite a membrane 4 coupled to the piezoelectric element 2. Due to excitation, the membrane 4 can perform a displacement 60. The piezoelectric element 2 and the membrane 4 are arranged in a housing 11. It is possible that the controlling electronics 3 are also arranged in the housing 11. The controlling electronics 3 are, for example, a microcontroller.

The actuating means 21 can excite the membrane 4 with an actuating signal 6 so that an ultrasonic signal 7 is emitted. After the ultrasonic signal 7 is emitted, the membrane 4 typically continues to oscillate, i.e., it continues to perform a ringing 40.

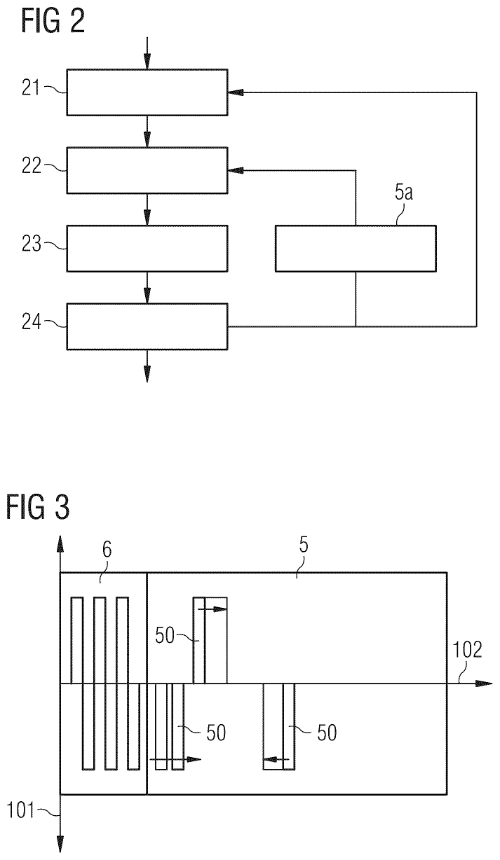

FIG. 2 illustrates a method for operating the ultrasonic transducer 1 of FIG. 1. The actuating means 21 excites the membrane 4 to emit an ultrasonic signal 7. The damping means 22 damps the ringing 40 of the membrane 4 by means of a damping signal 5. In particular, after damping, the detecting means 23 detects an amplitude of the ringing 40. The adapting means 24 determines the damping signal 5 depending on the amplitude of the ringing 40 detected by the detecting means 23. For this purpose, the adapting means 24 comprises an optimization algorithm executed on the controlling electronics 3. If a damping signal 5 is already known, for example from a previous performance of the steps of the method, the adapting means can adapt the damping signal 5 and determine an adapted damping signal 5a. The adapted damping signal 5a is preferably optimized by the optimization algorithm. By means of the adapted damping signal 5a, the damping means 22 can, in particular, perform more effective damping of the ringing 40 of the membrane 4.

The method of operation can preferably be performed multiple times during the intended operation of the ultrasonic transducer 1, for example each time an ultrasonic signal 7 is emitted, as indicated in FIG. 2. Thereby, the damping signal 5, 5a can be continuously optimized, which enables particularly effective damping of the ringing 40. Furthermore, the adapting means 24 can respond to changed environmental conditions, measurement conditions, or application requirements in order to be able to respond to such changes with an adapted damping signal 5a.

FIG. 3 illustrates an actuating signal 6 with which the membrane 4 is excited by means of the actuating means 21. The actuating means 6 comprises square pulses which are applied in a time-e sequence 102 with a voltage 101. The voltage 101 has a fixed amplitude, with the sign changing after each square pulse.

In order to dampen the ringing 40 of the membrane 4, a damping signal 5 is provided for the damping means 22 by means of the controlling electronics 3. The damping signal 5 comprises at least one damping pulse 50. The controlling electronics 3 are configured to determine at least one parameter of the damping signal from the following parameters: number 51 of damping pulses, width 52 of damping pulses 50, and sequence 53 of damping pulses 50. In particular, the damping signal 5 follows immediately after the actuating signal 6. This means that there is no waiting period between the actuating signal 6 and the damping signal 5.

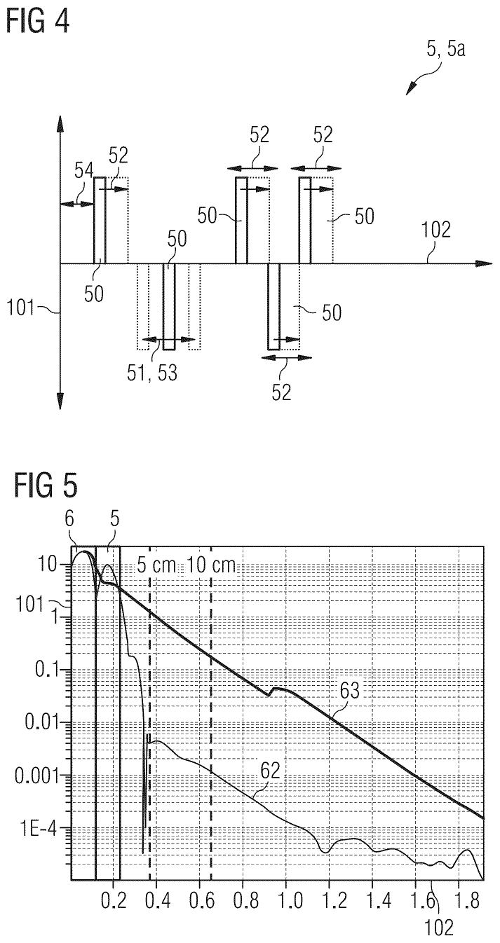

FIG. 4 illustrates a damping signal 5 as used in the method described here for operating an ultrasonic transducer 1. The damping signal 5 comprises a plurality of damping pulses 50, all of which have the same amplitude. The signs of the damping pulses 50 may vary and are determined, for example, by the controlling electronics 3.

The controlling electronics 3 determine, for example, the width 52 of the damping pulses 50. The width 52 results from the time 102 during which the voltage 101 is applied.

Furthermore, the number 51 of damping pulses 50 is determined by the controlling electronics, as is a sequence 53 of the damping pulses 50. The sequence 53 of the damping pulses 50 specifies the temporal sequence in which the damping points 50 occur in the damping signal 5. Furthermore, the sequence 53 specifies after which waiting period 54 a first damping pulse 50 occurs in the damping signal 5.

FIG. 5 shows the signal of a membrane displacement 62 of a membrane 4, which is damped by a damping signal 5 described here, in comparison to a comparative example of a membrane displacement signal 63, which is not damped. The membrane displacements 60, 61 can be converted via the piezoelectric effect into a voltage 101 (specified in V), which is plotted in FIG. 4 as a function of time 102 (specified in ms). During excitation with the actuating means 24, a voltage 101 associated with both membrane displacements 60, 61 is greater than 10 V. The actuating signal 6 is applied for approximately 0.1 ms.

The actuating signal 6 is immediately followed by the damping signal 5 in the case of membrane displacement 60. The damping signal 5 is applied for approximately 0.1 ms. A comparison of the voltage 101 curves for the damped membrane displacement 60 and the undamped membrane displacement 61 of the comparative example shows that the voltage 101 of the damped membrane displacement 60 is approximately two orders of magnitude lower than the voltage 101 of the comparative example 61 from approximately 0.4 ms onwards. The damping signal 5 thus effectively dampens the membrane displacement 60.

The dashed vertical lines in FIG. 5 illustrate times at which, after an ultrasonic signal 7 is emitted from the ultrasonic transducer 1 to an object 5 cm or 10 cm away, an ultrasonic signal reflected by the object reaches the ultrasonic transducer 1 again. A relationship between distance and time results from the speed of sound of the ultrasonic signal 7. For both an object at a distance of 5 cm and at a distance of 10 cm, the voltage 101 associated with the damped membrane displacement 60 is approximately two orders of magnitude smaller than the voltage 101 associated with the undamped membrane displacement 61. This means that the distance to these objects can be effectively determined using a damped membrane displacement 60 by means of the ultrasonic transducer.

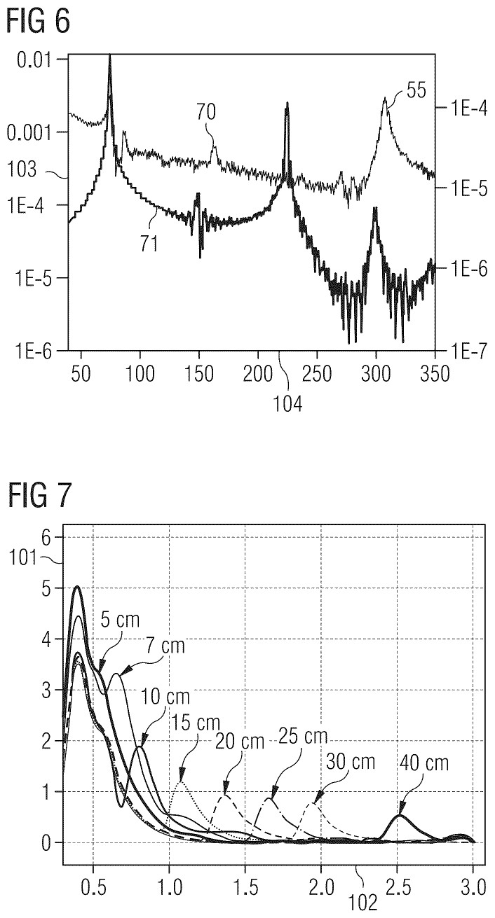

FIG. 6 illustrates which frequency components are present in the ringing 40 of the membrane 4 when the damping signal 5 is applied and in a comparative example in which no damping signal 5 is applied. The amplitude 103 of an oscillation signal obtained in particular from the membrane displacement 60, 61 is shown as a function of the frequency 104 (given in kHz). When the ringing 40 is damped (compare curve 70), a damping mode 55 is excited. The damping mode 55 is not present in the comparative example 71. The damping mode 55 effectively damps the damped membrane displacement 60 (see FIG. 4).

FIG. 7 illustrates a Hilbert envelope for various signals measured during distance measurement using the ultrasonic transducer 1. The signals correspond to membrane displacements 60, from which an associated voltage 101 (specified in mV) is obtained over a time 102 (specified in ms). At the maximum of the Hilbert envelope of these signals, the distance of the object is determined from the transit time of a transmitted ultrasonic signal 7 and an ultrasonic signal reflected by the object to be measured, together with the speed of sound of the ultrasonic signal.

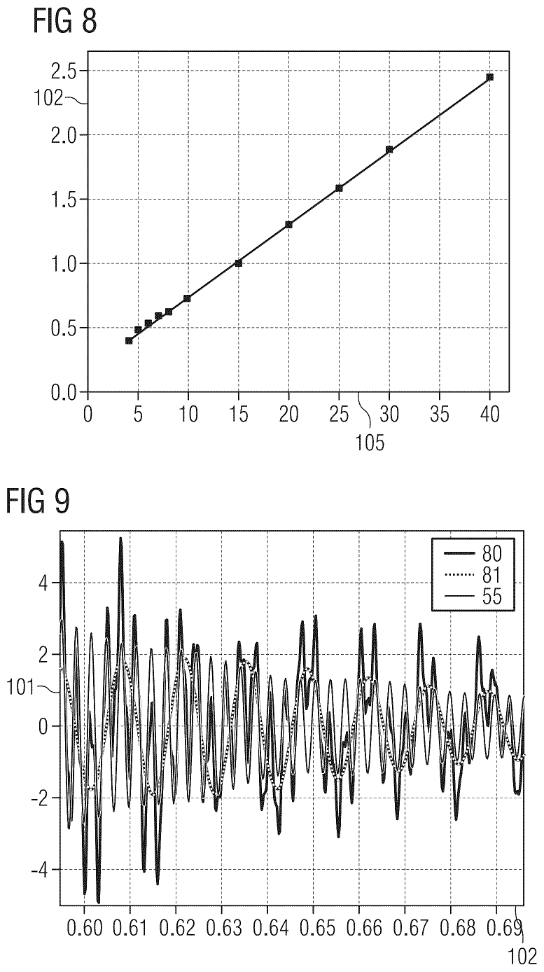

FIG. 8 shows a graphical representation in which a time 102 (specified in ms) at which the reflected ultrasonic signal is detected is shown as a function of the distance 105 (specified in cm) of the corresponding objects.

FIGS. 7 and 8 show that distances of up to 5 cm from the ultrasonic transducer 1 can be measured. In particular, only a single ultrasonic transducer is used for distance measurement.

FIG. 9 shows a signal 80 of a damped membrane displacement 60 as voltage 101 specified in mV as a function of time 102 specified in ms. The signal 80 is, for example, detected by the detecting means 23 after damping with the damping means 22. FIG. 9 further illustrates that the signal 80 contains a frequency 81 of the actuating signal 6 and the damping mode 55. For this purpose, the signal 80 was filtered with a narrow-band bandpass filter around the frequency 81 of the actuating signal 6 and the damping mode 55. As can be seen in FIG. 9, both the actuating signal 6 and the damping mode 55 are contained in the signal 80.

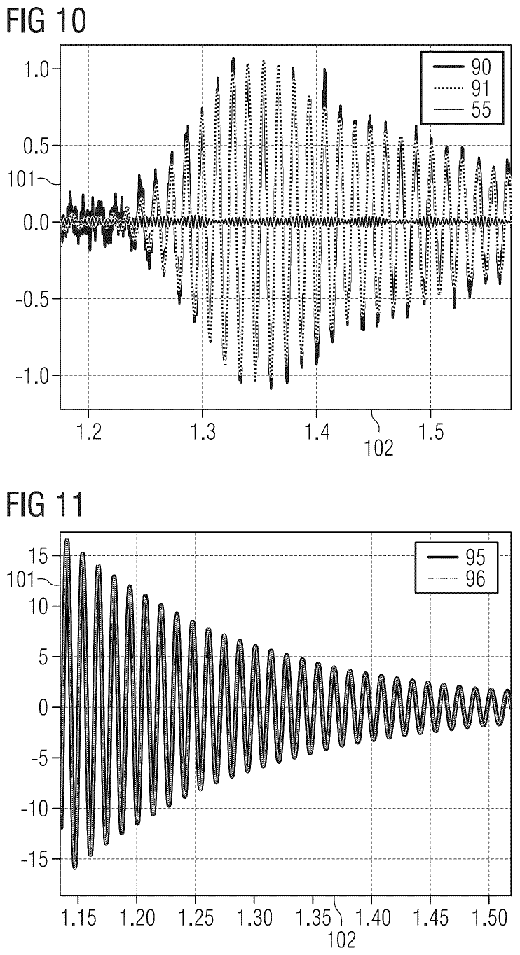

FIG. 10 shows a signal 90 of an ultrasonic signal that has been reflected by an object to be measured and is received by the ultrasonic transducer 1. The reflected ultrasonic signal generates a membrane displacement 60, which can be represented as a voltage 101 in mV via the piezoelectric effect. Signal 90 contains one signal each with the frequency 91 of actuating signal 6 and damping mode 55, which can be represented from signal 90 in a manner analogous to FIG. 9. As can be seen in FIG. 10, damping mode 55 has only a small proportion in signal 90. Thus, the damping mode 55 has only a negligible influence on the result of a distance measurement. Furthermore, a maximum of an envelope of the signal 90 is recognizable, which can be used to determine the distance of the object. In the present example, the distance of the object from the ultrasonic transducer is 15 cm.

In contrast to FIG. 10, FIG. 11 shows a comparison signal 95 of an ultrasonic signal reflected by the object to be measured, without any ringing of the membrane 4 due to the damping signal 5. As can be seen in FIG. 11, the comparison signal 95 is essentially determined by a frequency 96 of the actuating signal 6, and an envelope of the comparison signal 95 decreases continuously. This means that the distance of the object from the ultrasonic transducer cannot be determined.

Furthermore, a comparison with FIG. 10 shows that the comparison signal 95 has an amplitude that is an order of magnitude higher than that of the signal 90. This means that all information in the comparison signal 95 that could be used to determine the distance of the object is masked by the ringing of membrane 4, so that the distance of the object cannot be determined.

1.-20. (canceled)

21. An ultrasonic transducer comprising:
an actuator;
a damper;
a detector;
an adapter; and
a membrane,
wherein the actuator is configured to excite the membrane to emit an ultrasonic wave,
wherein the damper is configured to dampen a ringing of the membrane occurring after excitation by a damping signal,
wherein the detector is configured to detect an amplitude of the ringing of the membrane, and
wherein the adapter is configured to determine the damping signal based on the detected amplitude of the ringing.

22. The ultrasonic transducer according to claim 21, wherein the actuator, the damper, and the detector comprise a piezoelectric element.

23. The ultrasonic transducer according to claim 21, wherein controlling electronics are configured to provide the damping signal.

24. The ultrasonic transducer according to claim 23, wherein the actuator is configured to excite the membrane by an actuating signal, and wherein the controlling electronics are configured to provide the actuating signal.

25. The ultrasonic transducer according to claim 24, wherein the damping signal is phase-shifted by 180° relative to the actuating signal.

26. The ultrasonic transducer according to claim 24, wherein the damping signal and the actuating signal have the same amplitude.

27. The ultrasonic transducer according to claim 21, wherein the damping signal comprises at least one damping pulse and the adapter is configured to determine at least one of the following parameters of the damping signal based on the detected amplitude of the ringing: number of damping pulses, width of the at least one damping pulse, or sequence of the at least one damping pulse.

28. The ultrasonic transducer according to claim 27, wherein the damping signal comprises a number between 2 and 10 damping pulses, inclusive.

29. The ultrasonic transducer according to claim 27, wherein a width of the at least one damping pulse is between 0.02 and 0.1 milliseconds, inclusive.

30. The ultrasonic transducer according to claim 27, wherein the damping signal has at least two damping pulses and a time interval between two consecutive damping pulses is between 0.02 and 0.1 milliseconds, inclusive.

31. The ultrasonic transducer according to claim 27, wherein a waiting period between an end of excitation by the membrane by the actuator and a first damping pulse of the damping signal is between 0.02 and 0.1 milliseconds, inclusive.

32. The ultrasonic transducer according to claim 27, wherein the damping signal comprises at least two damping pulses and the damping pulses of the damping signal have the same amplitude and/or the same pulse shape.

33. The ultrasonic transducer according to claim 21, wherein the adapter comprises an optimization algorithm executed on controlling electronics, and wherein the optimization algorithm is configured to determine an adapted damping signal based on the detected amplitude of the ringing.

34. The ultrasonic transducer according to claim 33, wherein an amplitude of the ringing of the membrane damped by the adapted damping signal has a lower value than an amplitude of the ringing of the membrane damped by the damping signal.

35. The ultrasonic transducer according to claim 21, wherein the membrane has a freely oscillating surface area of at least one square millimeter.

36. The ultrasonic transducer according to claim 21, wherein the damper is configured to excite a damping mode of the membrane.

37. A method for operating an ultrasonic transducer, the method comprising:
exciting, by an actuator, a membrane to emit an ultrasonic wave;
damping, by a damper, an amplitude of a ringing of the membrane;
detecting, by a detector, the amplitude of the ringing of the membrane at least at one timing after damping by the damper; and
determining, by adaptor, an adapted damping signal based on the amplitude of the ringing detected by the detector.

38. The method according to claim 37, wherein the steps are performed multiple times in the specified order, and wherein the adapted damping signal determined in a previous execution of the steps is used in each execution of the steps.

39. The method according to claim 37,
wherein the actuator excites the membrane with an actuating signal,
wherein the damper dampens the amplitude of the ringing of the membrane by the damping signal, and
wherein the damping signal follows the actuating signal without any waiting period.

40. A method for measuring distance, the method comprising:
providing exactly one ultrasonic transducer according to claim 21; and
measuring an object at a distance between 4 cm and 2 m, inclusive.
